(19) United States
(12) Patent Application Publication
(10) Pub. No.: US 2026/0285099 A1
(43) Pub. Date: Sep. 24, 2026

(54) TOOL AND METHOD FOR SETTING TIRE PRESSURE MONITORING SYSTEM SENSOR, AND TPMS SENSOR SETTING SYSTEM

(71) Applicant: Orange Electronic Co., Ltd, Taichung City (TW)

(72) Inventors: Yi-sheng LIN, Taichung City (TW); Ming-yung HUANG, Taichung City (TW)

(73) Assignee: Orange Electronic Co., Ltd, Taichung City (TW)

(21) Appl. No.: 19/083,577

(22) Filed: Mar. 19, 2025

(51) Int. Cl. B60C 23/04; G06K 7/14

(52) U.S. Cl. CPC B60C 23/0471; G06K 7/1413

(57) ABSTRACT

A tool for setting a TPMS sensor paired with a barcode. The tool includes a case body and a processing device. The case body includes a user interface comprising a function device and an image capture device. The processing device is electrically to the user interface and includes a processor, a memory unit, and a signal transceiver. The vehicle information data is corresponding to a plurality of communication protocols and stored in the memory unit to be selectable under control of the function device. A barcode decoding program is configured to obtain TPMS sensor information encoded on the barcode. In response to obtaining the TPMS sensor information, the signal transceiver transmits a burning command to the TPMS sensor paired with the barcode, and the burning command enables the communication protocol being selected to be burned to the TPMS sensor paired with the barcode.

### BACKGROUND OF INVENTION

### 1. Field of Invention

The present invention relates to a technical field of tire pressure monitoring system (TPMS) sensors, and particularly to a tool and a method for setting a TPMS sensor, and a TPMS sensor setting system.

### 2. Related Art

Tire pressure monitoring system (TPMS) sensors are installed t valve stems of pneumatic tires which monitor various conditions of tires, for example tire air pressure and tire temperature. If a measured tire air pressure drops below a predetermined level, TPMS sensors will send a wireless signal to a vehicle's electronic control unit (ECU) or other control system, to alert a driver of the low tire air pressure. Each TPMS tire sensor generally includes its own specific identification code so the vehicle ECU can distinguish between tires on a vehicle.

When new vehicles are manufactured or when TPMS tire sensors are to be replaced, it is required to carry out initial programming or calibration of TPMS tire sensors. Because vehicle makes use their own communication protocols for the communication between vehicle ECU and TPMS tire sensors, a corresponding communication protocol must be burned into each TPMS sensor after its installation. Accordingly, TPMS tools have been developed which can wirelessly identify specific sensor IDs in tires. In use, a TPMS tool is sequentially brought into close proximity to the exterior of each tire or close to the TPMS tire sensors, which have not yet installed in the tires to send an electronic signal which is received by an adjacent sensor to activate, trigger or awaken the sensor. However, the wireless signal triggering method can easily trigger all or other TPMS tire sensors within the signal receiving area around the tool, causing the tool to receive the ID of a non-target sensor, resulting in the communication protocol being burned into the wrong sensor. In addition, conventional tools require manual selection of sensors IDs, which is time-consuming as well as troublesome, and is susceptible to inaccurate burning.

### SUMMARY OF THE INVENTION

An object of the present invention is to provide a tool and a method for setting a tire pressure monitoring system (TPMS) sensor, which is simple and capable of burning TPMS sensors accurately.

To achieve the above object, the present application provides a tool for setting a tire pressure monitoring system (TPMS) sensor, the TPMS sensor paired with a barcode. The tool comprises a case body and a processing device disposed in the case body. The case body comprises a user interface comprising a function device and an image capture device positioned on the case body for capturing an image of the barcode under control of the function device. The processing device is electrically connected to the user interface and comprises a processor; a memory unit electrically connected to the processor; vehicle information data corresponding to a plurality of communication protocols stored in the memory unit, the vehicle information data displayable on the display and selectable under control of the function device; a barcode decoding program stored in the memory unit and configured to be executed by the processor to obtain TPMS sensor information encoded on the barcode; and a signal transceiver electrically connected to the processor and configured to transmit, in response to obtaining the TPMS sensor information, a burning command to the TPMS sensor paired with the barcode, and the burning command enabling the communication protocol being selected to be burned to the TPMS sensor paired with the barcode.

Optionally, the vehicle information data contains a plurality of vehicle makes, vehicle models, and vehicle years that are corresponding to respective communication protocols selectable under control of the function device, and the TPMS sensor information comprises identification code of the TPMS sensor.

Optionally, the tool generates, in response to obtaining the TPMS sensor information, the burning command and automatically sends the burning command to the TPMS sensor paired with the barcode through the signal transceiver.

Optionally, the tool sends, in response to determining that the barcode is void of the identification code of the TPMS sensor, an alert message displayed on the display.

Optionally, the barcode is a two-dimensional code.

Optionally, the barcode is attached to the TPMS sensor and/or a sensor packaging.

Optionally, the image capture device is configured to capture an image of a plurality of the barcodes, and the barcode decoding program is configured to decode the TPMS sensor information of the plurality of barcodes of the image.

Optionally, the function device comprises a function input module and a display, the function input module comprises at least an input key, and the vehicle information data is displayed on the display and is selectable under control of the input key and/or the display.

The present application further provides a method for setting TPMS sensor, the TPMS sensor paired with a barcode. The method comprises providing a tool comprising a case body and a processing device in the case body. The case body comprises a user interface comprising a function device and an image capture device, and the processing device comprises a processor, a memory unit, and a signal transceiver electrically connected to the processor. The method comprises determining, by selecting vehicle information data stored in the memory unit under control of the function device, a communication protocol; capturing, by using the image capture device, an image of the barcode under control of the function device; obtaining, by using a barcode decoding program stored in the memory unit and configured to be executed by the processor, TPMS sensor information encoded on the barcode; and burning, by using the tool to send a burning command to the TPMS sensor through the signal transceiver, the communication protocol to the TPMS sensor paired with the barcode.

Optionally, the step of burning the communication protocol to the TPMS sensor paired with the barcode comprises the tool generates, in response to obtaining the TPMS sensor information, the burning command and automatically sends the burning command to the TPMS sensor paired with the barcode through the signal transceiver.

In the present application, the tool and the method for setting a TPMS sensor, and the TPMS sensor setting system use the barcode to pair with the TPMS sensor, thereby preventing incorrect alignment between the communication protocol and the TPMS sensor, which is caused by conventional wireless signal triggering. In addition, the communication protocol burning operation of the present application immediately following the obtaining of the TPMS sensor information reduces the time for the entire burning procedure, thus solving the time-consuming and troublesome burning problem in prior art.

### BRIEF DESCRIPTION OF DRAWINGS

FIG. 1 is a flowchart of a method for setting a tire pressure monitoring system (TPMS) sensor in accordance with an embodiment of the present application.

FIG. 2 is a schematic structural view of a tool for setting a TPMS sensor in accordance with an embodiment of the present application.

FIG. 3 is a schematic functional block diagram of the tool of FIG. 2.

FIG. 4 is a flowchart of a method for setting a TPMS sensor in accordance with another embodiment of the present application.

FIG. 5 is a flowchart of a method for setting a TPMS sensor in accordance with another embodiment of the present application.

FIG. 6 is a schematic view showing a process of capturing a plurality of barcodes through an image capture device in accordance with an embodiment of the present application.

FIG. 7 is a schematic functional block diagram of a TPMS sensor setting system in accordance with an embodiment of the present application.

### DESCRIPTION OF PREFERRED EMBODIMENTS

The following embodiments are referring to the accompanying drawings for exemplifying specific implementable embodiments of the present invention. Directional terms described by the present invention, such as upper, lower, front, back, left, right, inner, outer, side, etc., are only directions by referring to the accompanying drawings, and thus the used directional terms are used to describe and understand the present invention, but the present invention is not limited thereto.

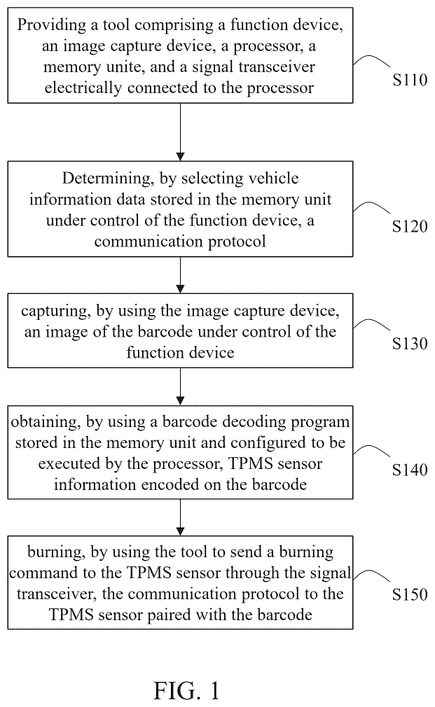

The present application provides a method for setting a tire pressure monitoring system (TPMS) sensor, which is paired with a barcode. The TPMS sensors are installed to valve stems of pneumatic tires. Referring to FIG. 1, which is a flowchart of a method 10 for setting a TPMS sensor in accordance with an embodiment of the present application, as shown in FIG. 1, the method 10 includes steps S110~S150 as follows:
Step S110: providing a tool including a case body and a processing device in the case body, wherein the case body including a user interface comprising a function device, a display, and an image capture device, and the processing device includes a processor, a memory unit, and a signal transceiver electrically connected to the processor.

In some embodiments, the tool may be a hand-held device, the function device allows users to operate for performing certain functions, and the image capture device is an optical scanner or camera for use in directly scanning, reading, or imaging information or data from a barcode. In some embodiments, the processor is configured to control the overall operation of the tool.
Step S120: determining, by selecting vehicle information data stored in the memory unit under control of the function device, a communication protocol.

The vehicle information data includes, but not limited to, a plurality of vehicle makes, vehicle models, and vehicle years, that are corresponding to respective communication protocols and are stored in the memory unit. The vehicle information data is shown on the display and is selectable under control of the function device. Specifically, a set of one of the vehicle makes, one of the vehicle models, and one of the vehicle years is corresponding to a unique communication protocol. The vehicle information data is to be selected prior to carrying out the subsequent steps.
Step S130: capturing, by using the image capture device, an image of the barcode under control of the function device.

In step S130, the image capture device is operated to capture an image of the barcode under control of the function device. In some embodiments, the barcode is a two-dimensional code, preferably a quick response code (QR) code. The barcode may be attached to the TPMS sensor, or may be attached to a sensor packaging for ease of scanning.
Step S140: obtaining, by using a barcode decoding program stored in the memory unit and configured to be executed by the processor, TPMS sensor information encoded on the barcode.

In response to capturing the image of barcode, the barcode decoding program is automatically executed by the processor to retrieve the TPMS sensor information encoded on the barcode. In some embodiments, the TPMS sensor information includes identification code of the TPMS sensor. Specifically, the identification code (ID) of a TPMS sensor refers to the identification code of the TPMS sensor itself. Each TPMS sensor has a unique identification code. A tire pressure receiver or a vehicle's ECU will identify each TPMS sensor through a tire pressure signal it receives which contains the identification code. For example, if two TPMS sensors are installed in the left front wheel and the right front wheel, they will be different. The tire pressure receiver or the vehicle's ECU will distinguish whether the tire pressure signal is from the left front wheel or the right front wheel through the tire pressure signal it receives which contains the ID.
Step S150: burning, by using the tool to send a burning command to the TPMS sensor through the signal transceiver, the communication protocol to the TPMS sensor paired with the barcode.

In step S150, in response to obtaining the TPMS sensor information, the tool generates the burning command and automatically sends the burning command to the TPMS sensor paired with the barcode through the signal transceiver. In some embodiments, the signal transceiver is configured to send a low frequency signal, typically a radio frequency of 125 KHz, and is configured to receive a high frequency signal, typically a frequency of 315 MHz or 433 MHz, from the TPMS sensor, but the signal frequency is not limited thereto.

In some embodiments, Step S120 may be performed after Step S140. Specifically, the step of determining the communication protocol may be performed after obtaining the TPMS sensor information encoded on the barcode.

In some embodiments, a step of selecting the number of TPMS sensors to be burned, for example, such as one, two, three, or four TPMS sensors, under the control of the function device may be performed between Step S120 and Step S130, or after Step S140.

In some embodiments, after completion of Step S140, the identification code may be shown on function device. Specifically, when there are multiple sets of identification codes obtained from the TPMS sensor information encoded on a plurality of the barcodes, for example, such as two sets of the identification codes, the multiple sets of identification codes are shown on the function device, which allows for selection of any set of the identification codes prior to the burning.

In some embodiments, when the action of scanning a barcode or manually entering an ID is executed, the tool is configured to operate at a preset time. When the preset time is reached and there is no further scanning of a barcode or manual entry of an ID, the tool will determine the number of barcodes to be scanned or the number of IDs to be manually entered.

In some embodiments, after burning, the tool provides a check command, enabling each TPMS sensor to feed back check data after receipt of the check command, which checks data containing the ID code of the respective TPMS sensor.

Specifically, when receiving the check data sent back by each TPMS sensor, the tool will perform a checksum calculation to confirm that the burning process is successfully completed. During the burning process, all selected TPMS sensors will continue to be monitored. If the TPMS sensors continue to respond correctly, the burning process will continue. If any one of the TPMS sensors does not respond during the burning process, it means that the burning on the TPMS sensor that does not respond may have been interrupted, and the TPMS sensor failing to respond is defined as a pending TPMS sensor. Therefore, the communication protocol for burning must be resent to the pending TPMS sensor to determine whether the pending TPMS sensor can regain communication. The tool will issue a corresponding communication protocol for each selected TPMS sensor when performing communication protocol transmission, and can issue the check command together after the burning process on all the TPMS sensors is completed. Alternatively, the tool can also issue the check command for each single TPMS sensor separately after completing the burning on each TPMS sensor.

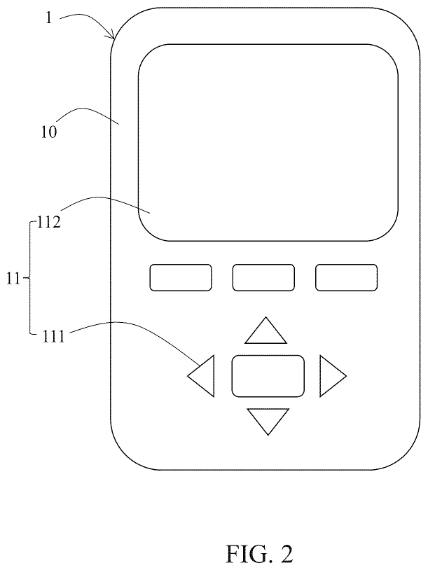

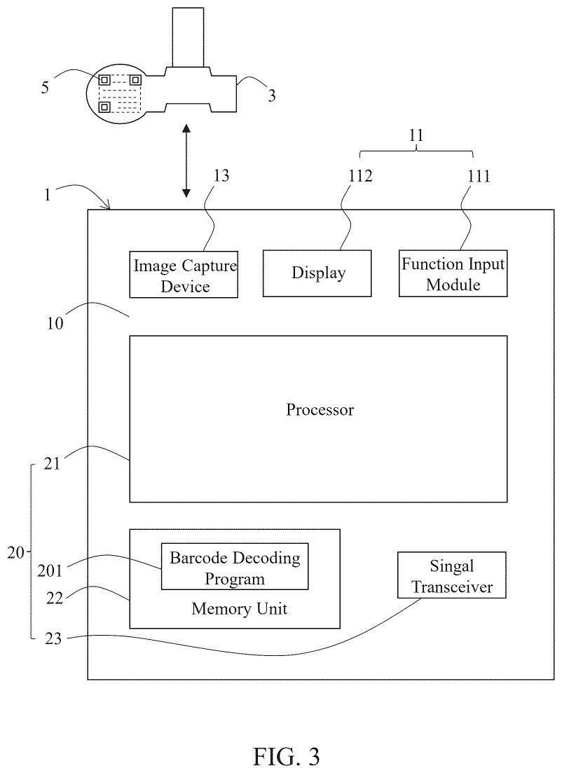

Referring to FIGS. 2 and 3, FIG. 2 is a schematic structural view of a tool for setting a TPMS sensor, and FIG. 3 is a schematic functional block diagram of the tool of FIG. 2. The present application provides a tool 1 used for setting a TPMS sensor 3 through the method as described in the embodiments of the application. As shown in FIGS. 2 and 3, the tool 1 includes a case body 10 and a processing device 20. The case body 10 includes a user interface including a function device 11 and an image capture device 13 positioned on the case body 10 for capturing an image of the barcode 5 under control of the function device 11.

As shown in FIG. 2, the function device 11 may have physical keys or buttons for operation. Specifically, the function device 11 may include a function input module 111 and a display 112. The function input module 111 includes at least an input key, and the vehicle information data is displayed on the display 112 and is selectable under control of the input key and/or the display 112. The display 112 may be, for example a light-emitting diode display for displaying the state of the tool 1 and items to be selected. In some embodiments, the function input module 111 and the display 112 may be integrated as a touch panel. In an embodiment, electrical power may be transferred to the tool 1 through a cable (not shown). Alternately, the tool 1 may be powered by rechargeable or disposable batteries (not shown).

As shown in FIG. 3, the processing device 20 is disposed in the case body 10 and electrically to the user interface. The processing device 20 includes a processor 21, a memory unit 22 electrically connected to the processor 21, a barcode decoding program 201 stored in the memory unit 22, and a signal transceiver 23 electrically connected to the processor 21. In some embodiments, the processor 21 may include one or more processors to execute instructions or programs and t hereby perform actions in all or part of the steps in the above TPMS setting method. Additionally, the processor 21 may include one or more modules that facilitate interaction between the processor and other components. For example, the processor 21 may be a microcontroller.

The memory unit 22 is configured to store various types of data to support the operation of the tool 1. Examples of such data include instructions for any application, program, or method for operating on the tool. The memory unit 22 can be implemented using any type of volatile or non-volatile memory device, or a combination thereof. The signal transceiver 23 is configured to transmit, in response to obtaining the TPMS sensor information, a burning command to the TPMS sensor 3 paired with the barcode 5. For descriptions of other functions performed by the tool 1 but not stated above, reference may be made to the above embodiments of the method, and will not be described again here.

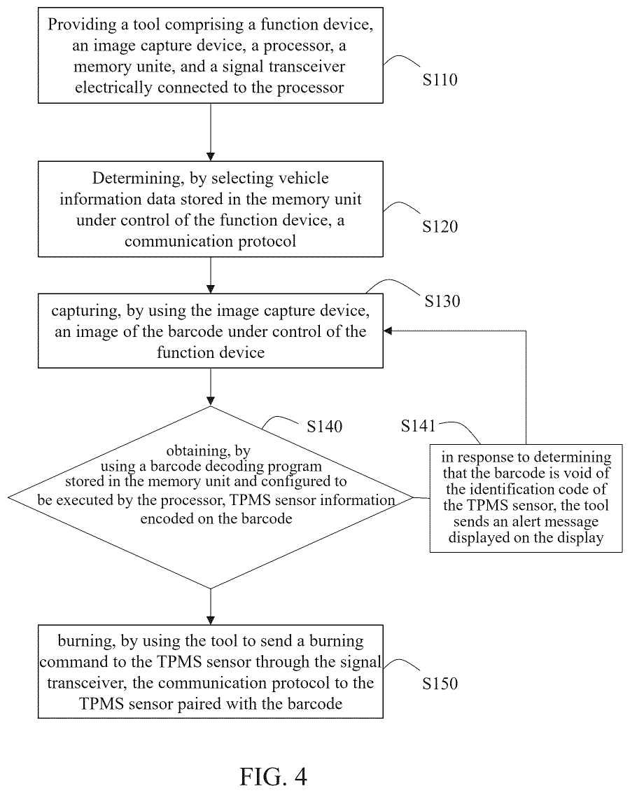

Referring to FIG. 4, which is a flowchart of the method in accordance with another embodiment, in this embodiment, the method further includes step S141: in response to determining that the barcode is void of the identification code of the TPMS sensor, the tool sends an alert message displayed on the display.

As shown in FIG. 4, when the barcode contains the information excluding the identification code, the tool sends the alert message, which is displayed on the display for the user to notice. In this manner, the step is back S130 to capture another barcode containing the TPMS sensor information, thereby preventing the tool from spending time on attempting to generate the burning command, that is, step S141 serves as a precaution against inappropriate alignment between the barcode and the TPMS sensor.

In some embodiments, the method further includes a mode selection step (not shown) where the tool may selectively operate in a default mode or in a selective mode prior to step S120 or between step S120 and step S130. When the tool is powered on and the mode selection step is not taken for a preset time period, for example three seconds, the tool automatically operates in the default mode to run from step S120 to S130. In the default mode the tool burns the communication protocol to the TPMS sensor as soon as the TPMS sensor information of an individual barcode is obtained. It should be noted that the tool is preferably preset in the default mode when the tool is powered on unless the mode selection step is additionally performed.

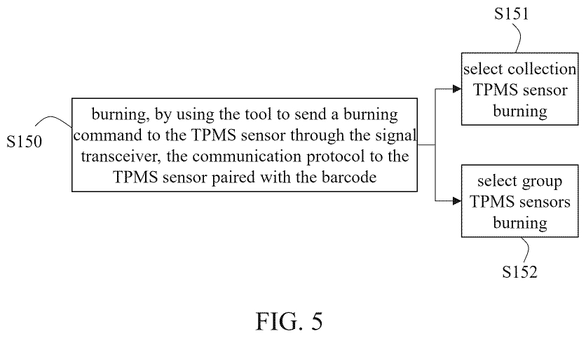

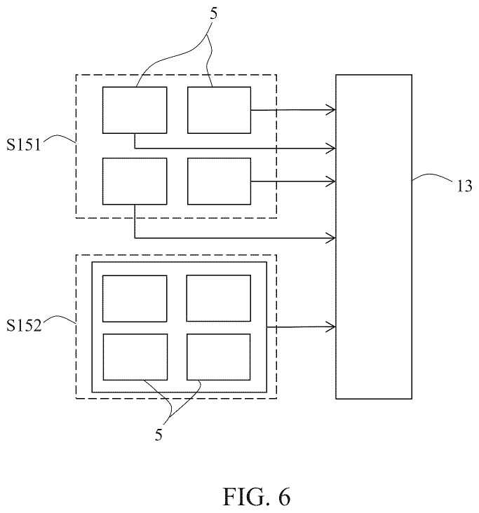

Referring to FIGS. 5 and 6, FIG. 5 is another flowchart of t method and FIG. 6 shows a process of capturing a plurality of barcodes through an image capture device. In this embodiment, the tool is being selected in the mode selection step to operate in the selective mode and thus step S150 further includes the following steps:
Step S151: select collection TPMS sensor burning. Specifically, the tool captures a plurality of images of the barcodes one by one, and when the number of the images reaches a preset number, for example four, the tool, in response to obtaining the TPMS sensor information of the four barcodes, generates and sends multiple burning commands to the TPMS sensors paired with the barcodes. Preferably, the plurality of images of the barcodes being captured one by one is set as the default mode.
Step S152: select group TPMS sensors burning. Specifically, the image capture device is configured to capture an image of a plurality of the barcodes at the same time, and the barcode decoding program is configured to decode the TPMS sensor information of the plurality of barcodes of the same image. Specifically, the number of barcodes in the same image is plural, preferably four for four tires in a vehicle. In detail, the barcode decoding program is configured to decode the TPMS sensor information of the four barcodes in the same image, and the tool, in response to obtaining the TPMS sensor information of the four barcodes, generates and sends multiple burning commands to the TPMS sensors paired with the barcodes.

In some embodiments, the identification code of the TPMS sensor can be manually inputted through the function device. In this embodiment, the identification code of the TPMS sensor is provided in advance for the manual inputting. For example, the identification code may be provided close to the barcode, imprinted on a surface of the TPMS sensor, or printed on a sensor packaging. In some embodiments, the function device may include a function input module and a display, the function input module includes at least an input key, and the vehicle information data is displayed on the display and is selectable under control of the input key and/or the display. The identification code as visually provided can be manually input through the function input module of the input key or the display, which may be embodied as a touch panel.

Based on the method of the present application, the method further includes a step that the tool is configured to transmit a check command to each selected TPMS sensor after completion of the communication protocol burning operation, enabling each selected TPMS sensor to feed back check data after receipt of the check command, and the check data containing the ID code of the respective TPMS sensor.

In some embodiments, all the selected TPMS sensors will be continuously monitored during the burning operation, and the burning operation keeps running if each of the TPMS sensors keeps providing the correct response. If there is any TPMS sensor that gives no response, re-send the communication protocol.

In some embodiments, the tool can be controlled to provide a clear command to the selected TPMS sensors to clear the stored communication protocol from their memories, ensuring sufficient memory space for receiving the burning command and the provided communication protocol.

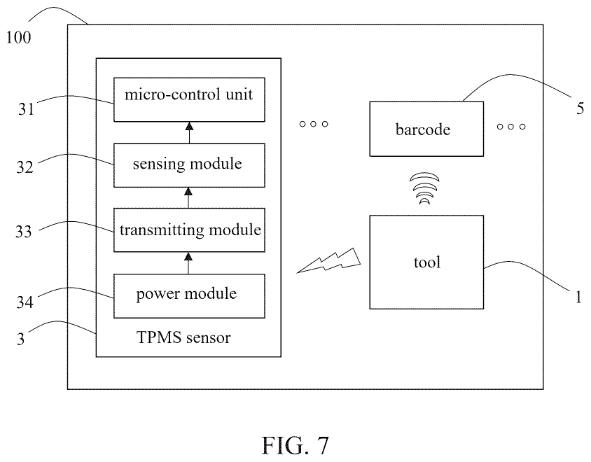

Referring to FIG. 7, the present application further provides TPMS sensor setting system 100, including a plurality of TPMS sensors 3, a plurality of barcodes 5, and the tool 1. Specifically, each of the TPMS sensors 3 includes a micro-control unit 31, and a sensing module 32, a transmitting module 33, and a power module 34 that are electrically connected to the micro-control unit 31.

In detail, the sensing module 32 is electronically connected to the micro-control unit 31 and may have a pressure-detecting unit, at least one acceleration-detecting unit, a temperature-detecting unit and/or the like. The sensing module 32 is controlled by the micro-control unit 31 to respectively detect continuously a tire pressure signal, acceleration direction signals and a tire temperature signal of the vehicle and send a detection result to the micro-control unit 31. Specifically, when two acceleration-detecting units are included, the two acceleration-detecting units may detect a turning acceleration and a tuning direction of the vehicle, where the turning acceleration and the tuning direction are calculated from the detection results of the acceleration-detecting units. The transmitting module 33 is controlled by the micro-control unit 31 to transmit a radio frequency (RF) signal, where the RF signal includes the detection results and may have the preset identification. The RF signal may have frequencies such as 315 MHz, 433 MHz or the like. The power module 34 is electronically connected to the micro-control unit 31 and provides electric power to the TPMS sensor 3.

The detailed description of the function and the operation of the tool 1, the TPMS sensors 3, and the barcodes 5 of the TPMS sensor setting system 100 are the same as the tool and the method for setting the TPMS sensor as stated in the aforementioned embodiments, and will not be repeated here.

Accordingly, the tool and the method for setting a TPMS sensor, and the TPMS sensor setting system provided in the present application use the barcode to pair with the TPMS sensor, thereby preventing incorrect alignment between the communication protocol and the TPMS sensor, which is caused by conventional wireless signal triggering. In addition, the communication protocol burning operation of the present application immediately following the obtaining of the TPMS sensor information reduces the time for the entire burning procedure, thus solving the time-consuming and troublesome burning problem in prior art.

It should be understood that the order of the steps of the method is exemplary only and that certain steps may be performed in various orders according to actual needs, unless otherwise specified.

Accordingly, although the present invention has been disclosed as a preferred embodiment, it is not intended to limit the present invention. Those skilled in the art without departing from the scope of the present invention may make various changes or modifications, and thus the scope of the present invention should be after the appended claims and their equivalents.

What is claimed is:

1. A tool for setting a tire pressure monitoring system (TPMS) sensor, the TPMS sensor paired with a barcode, the tool comprising:
a case body comprising a user interface comprising a function device and an image capture device positioned on the case body for capturing an image of the barcode under control of the function device; and
a processing device disposed in the case body and electrically to the user interface, the processing device comprising:
a processor;
a memory unit electrically connected to the processor;
vehicle information data corresponding to a plurality of communication protocols stored in the memory unit, the vehicle information data displayable on the function device and selectable under control of the function device;
a barcode decoding program stored in the memory unit and configured to be executed by the processor to obtain TPMS sensor information encoded on the barcode; and
a signal transceiver electrically connected to the processor and configured to transmit, in response to obtaining the TPMS sensor information, a burning command to the TPMS sensor paired with the barcode, and the burning command enabling the communication protocol being selected to be burned to the TPMS sensor paired with the barcode.

2. The tool of claim 1, wherein the vehicle information data contains a plurality of vehicle makes, vehicle models, and vehicle years that are corresponding to respective communication protocols selectable under control of the function device, and the TPMS sensor information comprises identification code of the TPMS sensor.

3. The tool of claim 2, wherein the tool generates, in response to obtaining the TPMS sensor information, the burning command and automatically sends the burning command to the TPMS sensor paired with the barcode through the signal transceiver.

4. The tool of claim 2, wherein the tool sends, in response to determining that the barcode is void of the identification code of the TPMS sensor, an alert message displayed on the display.

5. The tool of claim 1, wherein the barcode is a two-dimensional code.

6. The tool of claim 1, wherein the barcode is attached to the TPMS sensor and/or a sensor packaging.

7. The tool of claim 1, wherein the image capture device is configured to capture an image of a plurality of the barcodes, and the barcode decoding program is configured to decode the TPMS sensor information of the plurality of barcodes of the image.

8. The tool of claim 1, wherein the function device comprises a function input module and a display, the function input module comprises at least an input key, and the vehicle information data is displayed on the display and is selectable under control of the input key and/or the display.

9. A method for setting a tire pressure monitoring system (TPMS) sensor, the TPMS sensor paired with a barcode, the method comprising:
providing a tool comprising a case body and a processing device disposed in the case body, wherein the case body comprises a user interface comprising a function device and an image capture device, and the processing device comprises a processor, a memory unit, and a signal transceiver electrically connected to the processor;
determining, by selecting vehicle information data stored in the memory unit under control of the function device, a communication protocol;
capturing, by using the image capture device, an image of the barcode under control of the function device;
obtaining, by using a barcode decoding program stored in the memory unit and configured to be executed by the processor, TPMS sensor information encoded on the barcode; and
burning, by using the tool to send a burning command to the TPMS sensor through the signal transceiver, the communication protocol to the TPMS sensor paired with the barcode.

10. The method of claim 9, wherein the vehicle information data comprises a plurality of vehicle makes, vehicle models, and vehicle years that are corresponding to respective communication protocols selectable under control of the function device, and the TPMS sensor information comprises identification code of the TPMS sensor.

11. The method of claim 10, wherein the step of burning the communication protocol to the TPMS sensor paired with the barcode comprises using the tool to generate, in response to obtaining the TPMS sensor information, the burning command and automatically send the burning command to the TPMS sensor paired with the barcode through the signal transceiver.

12. The method of claim 10, wherein in response to determining that the barcode is void of the identification code of the TPMS sensor, the tool sends an alert message displayed on the display.

13. The method of claim 9, wherein the image capture device is configured to capture an image of a plurality of the barcodes, and the barcode decoding program is configured to decode the TPMS sensor information of the plurality of barcodes of the image.

14. The method of claim 9, wherein the barcode is a two-dimensional code.

15. The method of claim 9, wherein the barcode is attached to the TPMS sensor and/or a sensor packaging.

16. The method of claim 9, wherein the function device comprises a function input module and a display, the function input module comprises at least an input key, and the vehicle information data is displayed on the display and is selectable under control of the input key and/or the display.

17. A tire pressure monitoring system (TPMS) sensor setting system, comprising:
a plurality of TPMS sensors each comprising a micro-control unit, and a sensing module, a transmitting module, and a power module that are electrically connected to the micro-control unit;
a plurality of barcodes provided to be paired with the TPMS sensors, respectively; and
a tool comprising:
a case body comprising a user interface comprising a function device and an image capture device positioned on the case body for capturing an image of the barcode under control of the function device;
a processing device disposed in the case body and electrically to the user interface, the processing device comprising a processor, a memory unit, vehicle information data corresponding to a plurality of communication protocols stored in the memory unit, a barcode decoding program configured to be executed by the processor to obtain TPMS sensor information encoded on each of the barcodes, and a signal transceiver electrically connected to the processor and configured to transmit, in response to obtaining the TPMS sensor information, a burning command to each of the TPMS sensors paired with the barcode, and the burning command enabling the communication protocol being selected to be burned to each of the TPMS sensors paired with the barcode.

18. The TPMS sensor setting system of claim 17, wherein t vehicle information data contains a plurality of vehicle makes, vehicle models, and vehicle years that are corresponding to respective communication protocols selectable under control of the function device, and the TPMS sensor information comprises identification code of each of the TPMS sensors.

19. The TPMS sensor setting system of claim 18, wherein t tool generates, in response to obtaining the TPMS sensor information, the burning command and automatically sends the burning command to each of the TPMS sensors paired with the barcode through the signal transceiver.

20. The TPMS sensor setting system of claim 17, wherein each of the barcodes is a two-dimensional code.

21. The TPMS sensor setting system of claim 18, wherein after burning, the tool provides a check command, which enables each of the TPMS sensors to feed back check data after receipt of the check command for checking whether the check data contains the identification code of the respective TPMS sensor when receiving the check data sent back by each TPMS sensor.
